(19) United States
(12) Patent Application Publication
(10) Pub. No.: US 2006/0103686 A1
(43) Pub. Date: May 18, 2006

(54) Reflective fluidics matrix display particularly suited for large format applications

(76) Inventors: Robert M. Sikora, San Jose, CA (US); Sean P. McMahon, Santa Clara, CA (US)

Correspondence Address: John P. McMahon, 54 East Case Drive, Hudson, OH, 44236, US

(21) Appl. No.: 10/988,279

(22) Filed: Nov. 13, 2004

(51) Int. Cl. G01D 15/16

(52) U.S. Cl. 346/140.1

(57) ABSTRACT

A fluid matrix display is disclosed which is a reflective display that utilizes four colored dyes to create an image. Each of the dyes corresponds to one color in the CMYK color space. Each individually addressable pixel element of the fluid matrix display is composed of four-stacked pixel chambers. Each pixel chamber is valved to admit or expunge the colored dye to and from that pixel chamber. Images are created by writing appropriate colored dye data into each pixel chambers of each pixel element of the fluid matrix display.

### FIELD OF THE INVENTION

The invention relates to display subsystems and, more particularly, to a reflective microfluidics display particularly suited for large format applications that relies upon illumination from outside the display to strike the display and illuminate the image thereof, as opposed to an active display that produces illumination from within and consumes relatively more power thereof.

### BACKGROUND OF THE INVENTION

All displays, whether active or passive, must adhere to a color model. Red, green, blue (RGB) and its subset cyan, magenta, yellow (CMY) form the most basic and well-known color models. These models bear the closest resemblance to how humans perceive color. These models also correspond to the principles of additive and subtractive colors. Although these principles are applicable to all displays, these principles are of particular importance to the present invention and are to be further discussed herein.

Additive colors are created by mixing spectral light in varying combinations. The most common examples of this are television screens and computer monitors, which produce colored pixels by firing red, green, and blue electron guns at phosphors on the television or monitor screen. More precisely, additive color is produced by any combination of solid spectral colors that are optically mixed by being placed closely together, or by being presented to a human viewer in very rapid succession. Under either of these circumstances, two or more colors may be perceived as one color. This can be illustrated by a technique used in the earliest experiments with additive colors: color wheels. These are disks whose surface is divided into areas of solid colors. When attached to a motor and spun at high speed, the human eye cannot distinguish between the separate colors, but rather sees a composite of the colors on the disk.

Subtractive colors are seen by a human viewer when pigments in an object absorb certain wavelengths of white light while reflecting the rest of the wavelengths. Humans see examples of this principle all around them. More particularly, any colored object, whether natural or man-made, absorbs some wavelengths of light and reflects or transmits others; the wavelengths left in the reflected/transmitted light make up the color humans see.

This subtractive color principle is the nature of color print production involving cyan, magenta, and yellow, as used in four-color process printing. The colors cyan (C), magenta (M) and yellow (Y) are considered to be the subtractive primaries. The subtractive color model in printing operates not only with CMY, but also with spot colors, that is, pre-mixed inks.

Red, green, and blue are the primary stimuli for human color perception and are the primary additive colors and the relationship between the colors red, green, and blue, (known in the art) as well as cyan, magenta, and yellow (also known in the art) comprising the CMYK ingredients, where K signifies the color black, can be seen in FIG. 1 herein with regard to illustration 10. The formation of the color related to the RGB and CMYK color principles are shown by the illustration 12 of FIG. 2.

As may be seen in FIG. 2, the secondary colors of RGB, cyan, magenta, and yellow, are formed by the mixture of two of the primaries and the exclusion of the third. For example, red and green combine to make yellow, green and blue combine to make cyan, and blue and red combine to make magenta. The combination of red, green, and blue in full intensity makes white (shown in FIG. 1). White light is created when all colors of the EM spectrum converge in full intensity.

The importance of RGB as a color model is that it relates very closely to the way humans perceive color striking their receptors in their retinas. RGB is the basic color model used in television or any other medium that projects the color. RGB is the basic color model on computers and is used for Web graphics, but is not used for print production.

Cyan, magenta, and yellow correspond roughly to the primary colors in art production: blue, red, and yellow. FIG. 2 also shows the CMY counterpart to the RGB model.

As is known in the art, the primary colors of the CMY model are the secondary colors of RGB, and, similarly, the primary colors of RGB are the secondary colors of the CMY model. However, the colors created by the subtractive model of CMY do not exactly look like the colors created in the additive model of RGB. Particularly, the CMY model cannot reproduce the brightness of RGB colors. In addition, the CMY gamut is much smaller than the RGB gamut.

As seen in FIG. 3 for illustration 14, the CMY model used in printing lays down overlapping layers of varying percentages of transparent cyan, magenta, and yellow inks. As further seen in FIG. 3, white light is transmitted through the inks and reflects off the white surface below them (termed the substrate 16). The percentages of CMY ink (which are applied as screens of halftone dots), subtract inverse percentages of RGB from the reflected light so that humans see a particular color.

In the illustration 14 of FIG. 3 showing one example, the white substrate 16 reflects essentially 100% of the white light which is used for printing in cooperation with a 17% screen of magenta, a 100% screen of cyan, and an 87% screen of yellow. Magenta subtracts green wavelengths from the reflected light, cyan subtracts red wavelengths from the reflected light, and yellow subtracts blue wavelengths from the reflected light. The reflected light leaving the magenta screen, is made up of 0% of the red wavelengths, 44% of the green wavelengths, and 29% of the blue wavelengths.

When the reflected light is used for printing on paper, the screens of the three transparent inks (cyan, magenta, and yellow) are positioned in a controlled dot pattern called a rosette. To the naked eye, the appearance of the rosette is of a continuous tone, however when examined closely, the dots become apparent.

When used in printing on paper, the cyan screen at 100% prints as a solid layer; the 87% layer of yellow appears as green dots because in every case the yellow is overlaying the cyan, forming green. The magenta dots, at 17%, appear much darker because they are mostly overlaying both the cyan and yellow.

In theory, the combination of cyan (C), magenta (M), and yellow (Y) at 100%, create black (all light being absorbed). In practice, however, CMY usually cannot be used alone. Due to imperfections in the inks and other limitations of the process, full and equal absorption of the light is not possible. Because of these imperfections, true black or true grays cannot be created by mixing the inks in equal proportions. The actual result of doing so results in a muddy brown color. In order to boost grays and shadows, and provide a genuine black, printers resort to adding black ink, indicated as K in the CMYK method. Thus, the practical application of the CMY color model is a four color CMYK process.

This CMYK process was created to print continuous tone color images like photographs. Unlike solid colors, the halftone dot for each screen in these images varies in size and continuity according to the image's tonal range. However, the images are still made up of superimposed screens of cyan, magenta, yellow, and black inks arranged in rosettes.

In the process involving CMYK printing, though it is chiefly regarded as being dependent upon subtractive colors, the process is also an additive model in a certain sense. More particularly, the arrangement of cyan, magenta, yellow and black dots involved in printing appear to the human eye as colors because of an optical illusion. Humans cannot distinguish the separate dots at normal viewing size so humans perceive colors, which are an additive mixture of the varying amounts of the CMYK inks on any portion of the image surface.

The CMYK process involving the interactions of its ingredients has many benefits. One of the benefits is that the net resulting color does not require an external source, such as found in the RGB process related to active display systems, involving internal electron guns causing the excitation of phosphors on television and monitor displays. It is desired that an inactive display be provided that is free of any internal illumination source, such as electron guns and that uses a CMYK process and the attendant benefits thereof It is further desired that an inactive display be provided using a CMYK process that serves the needs of outdoor advertising.

Inactive displays using a CMYK process are known in the art and are commonly referred to as fluidic displays with one such display described in U.S. Pat. No. 6,037,955 ('955) entitled “Microfluidic Image Display.” The display disclosed in the '955 patent provides for a plurality of colored pixels, but requires the manipulation of at least first and second colored liquids for each chamber of each pixel. It is desired that an inactive display be provided that does not suffer the drawbacks of using at least first and second colored liquid for each chamber of each of the pixels being displayed.

An inactive display that is free of the limitation of using at least first and second colored liquids for each display is disclosed in our U.S. patent application Ser. No. 10/372,870 now U.S. Pat. No. 6,747,777B1 issued Jun. 8, 2004, with the disclosure thereof being herein incorporated by reference. Although the display described in our patent serves well its intended purpose, it is desired that further improvements be provided to microfluidics displays.

### OBJECTS OF THE INVENTION

It is a primary object of the present invention to provide an inactive display that is free of any internal illumination source and that uses a CMYK process and is particularly suited to serve the needs of outdoor advertising.

It is another object of the present invention to provide a fluidics matrix display that utilizes the mixture techniques of the CMYK process to supply an image thereof and that may be updated or changed in a relatively rapid manner.

Further still, it is another object of the present invention to provide for a reflective display panel responsive to pressurized communication paths and that preferably utilizes colored dyes.

Still further, it is an object of the present invention to provide a fluidics matrix display that utilizes four overlapping layers of colored die to create an image and with each of the four layers corresponding to one color in the CMYK color space.

In addition, it is an object of the present invention to provide individually addressable pixel elements composed of four stacked pixel chambers and with each pixel chamber being valved to admit or expunge the colored die to or from that pixel chamber. Images are created by writing the appropriate color die data to each pixel chamber in each pixel element of the fluidics matrix display.

### SUMMARY OF THE INVENTION

The present invention is directed to a fluidic matrix display system for large format applications that is particularly suited to the needs of indoor and outdoor advertising and utilizes the illumination from outside the display to illuminate the image being displayed. The system includes an addressing scheme, which serves two important functions. First, the scheme allows for the independent addressing of each pixel element so as to create an image where each pixel element will change from one image to the next image. Second, the scheme provides memory so a new image may be written while the current image is still being displayed.

The display system comprises: a) a plurality of pixel elements each comprising: a₁) a plurality of pixel chambers stacked on each other and with each pixel chamber having an input port and an output port; a₂) a plurality of air spring chambers each having an input port connected to a respective output of said plurality of said pixels chambers and a₃) a plurality of valves each having input, output, and control ports and each control port being responsive to a control signal so as to interconnect its input to its output port. The output ports thereof being connected to a respective input of the pixel chamber. The display system further comprises b) a plurality of sources of pressurized colored fluids.

### BRIEF DESCRIPTION OF THE DRAWINGS

Features and advantages of the invention, as well as the invention itself, will become better understood by reference to the following description when considered in conjunction with the accompanying drawings, wherein like reference numbers designate identical or corresponding parts thereof and wherein:

FIG. 1 is a prior art illustration showing the interrelationship of the ingredients of the RGB and CMYK color models;

FIG. 2 is a prior art illustration showing the color interactions related to the secondary colors of the RGB and CMYK models;

FIG. 3 is a prior art illustration showing the interaction of incident and reflected light associated with the CMYK color model;

FIG. 4 is a schematic of a single pixel element;

FIG. 5 is a simplified schematic of an array of pixel elements;

FIG. 6 is composed of FIGS. 6A and 6B, wherein FIG. 6A is a top view of a valve making up one of the pixel assemblies of the present invention, and FIG. 6B illustrates a side view of that same valve;

FIG. 7 is composed of FIGS. 7A, 7B, and 7C respectively illustrating the valve of FIG. 6 in its open position, the valve of FIG. 6 in its closed position, and an enlarged view of the diaphragm of the valve mating with the output port of the valve of FIG. 6;

FIG. 8 is a simplified schematic of a single pixel chamber having an associated pixel memory air chamber and activated by control signals associated with the addressing scheme of the present invention; and

FIG. 9 is a schematic of the addressing scheme for a single pixel chamber of the present invention.

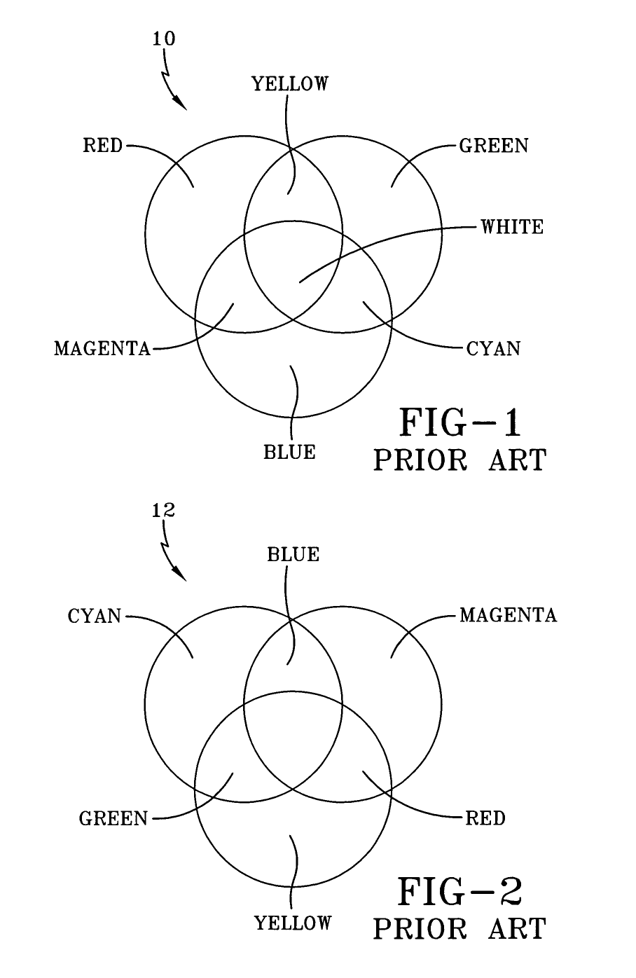

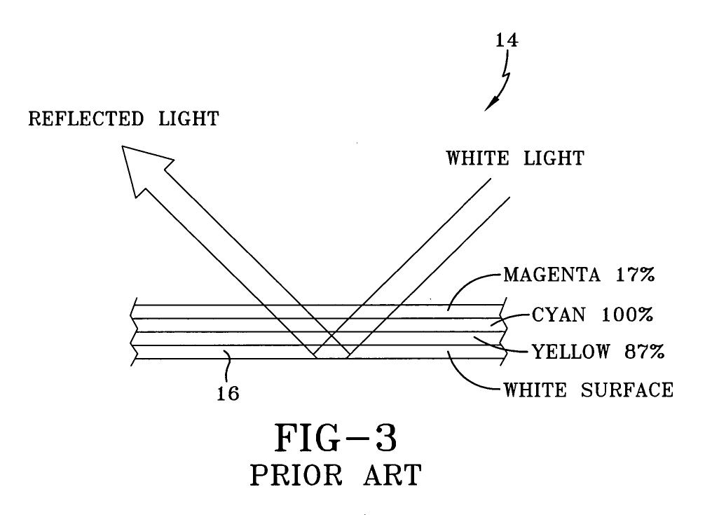

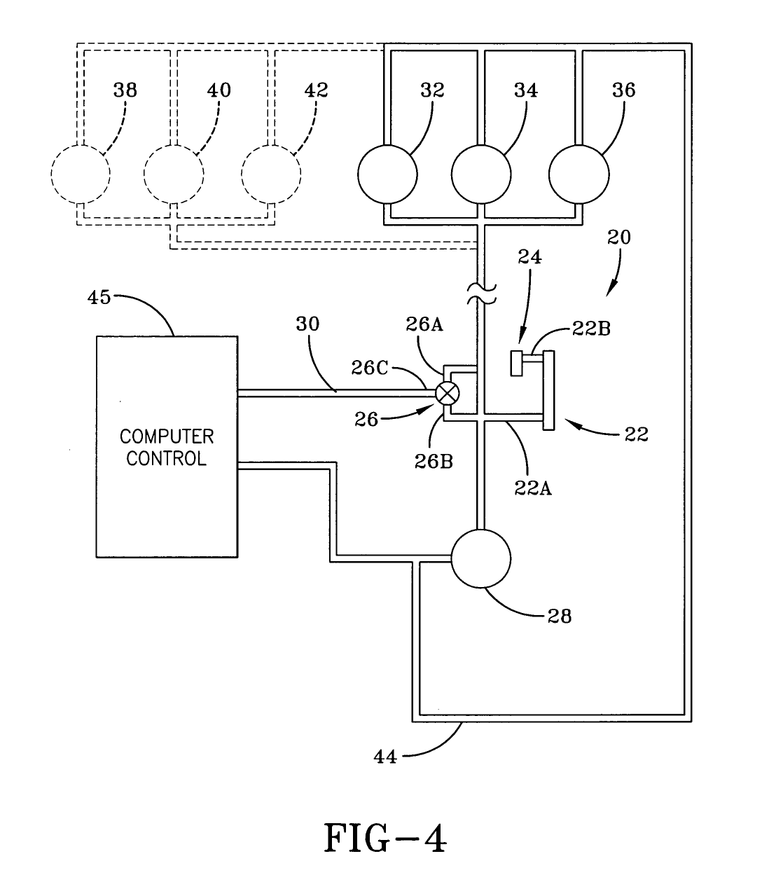

### DETAILED DESCRIPTION OF THE PREFERRED EMBODIMENTS

The reflective fluidics matrix display system 18 of the present invention, shown in FIG. 4, is passive, in that, it relies on illumination from outside the display to strike the display and illuminate the image as opposed to an active display that produces illumination for the image from within.

In general, and as will be further described in detail, the fluidics matrix display 18 is a reflective display that utilizes four overlapping layers of colored die to create an image. Each of the four layers corresponds to one color in the CMYK color space. Each of the pixel elements of the fluidics matrix display 18 is individually addressable and is composed of four stacked pixel chambers making up one of the colors in the CMYK color space. More particularly, each of the four stacked pixel chambers is individually addressable. Each of the four pixel chambers is valved to admit or expunge the colored die to or from that chamber. Images are created by writing the appropriate color die data to each of the four pixel chambers in each pixel element.

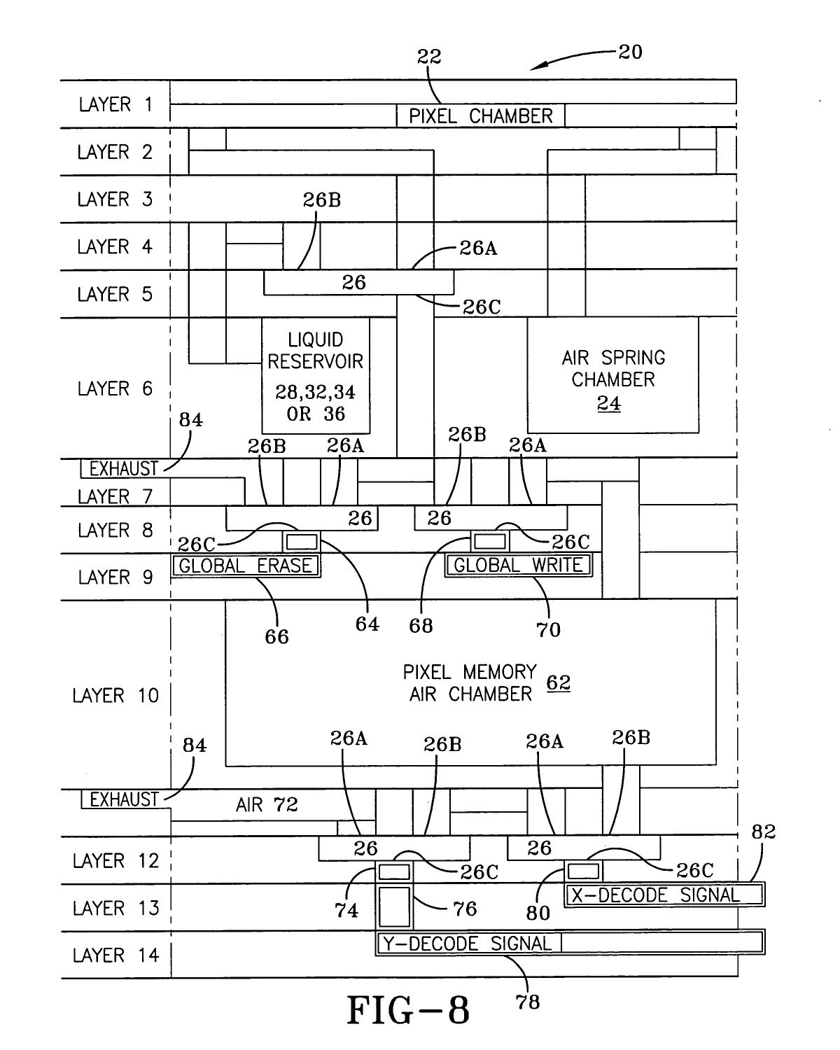

A single pixel element 20, shown in FIG. 4, is composed of four pixel chambers 22, four air spring chambers 24, four valves 26 and the pneumatic/hydraulic circuits to separately address each. A single pixel chamber 22, a single air spring chamber 24, a single valve 26 is schematically shown in FIG. 4, along with a single liquid reservoir 28 and a single liquid I/O control port signal 30. Not shown, but as will be further described hereinafter with reference to FIG. 8, each pixel chamber 22 has an associated pixel memory air chamber 62.

It should be noted, and as will be further described, each pixel chamber 22 can receive a colored fluid from reservoir 28 containing a cyan colored fluid, reservoir 32 containing a magenta colored fluid, reservoir 34 containing a yellow colored fluid, or reservoir 36 containing a black colored fluid operatively cooperating with each other so as to provide the CMYK color space. Alternately, each pixel chamber 22 can receive a colored fluid from reservoir 38 (shown in phantom) a red colored fluid, reservoir 40 (shown in phantom) containing a green colored fluid, or reservoir 42 (shown in phantom) containing a blue colored fluid all colors operatively cooperating with each other so as to provide the RGB color space model. All of the reservoirs 28, 32, 34, 36, 38, 40 and 42 are capable of being selectively pressurized by an appropriate control signal on signal bus 44 generated by computer control 45, which also generates control signal 30.

The fluidic matrix display 18 creates an image in the same manner as print media. Dyes or inks from reservoirs 28, 32, 34 and 36 adhering to the CMYK color model are layered together by the use of four pixel chamber 22 to act as the primary colors of a subtractive color system. As an example, white light is passed through magenta ink from reservoir 32 and yellow ink from reservoir 34 that have been layered by the use of two separate pixel chamber 22. The result is Red.

The fluid matrix display 18 is constructed of four independent and identical sections each constituting a pixel element 20 that are intertwined together against a white substrate to form one of the colors of the image being displayed by the fluid matrix display 18. Each section or pixel element 20 corresponds to one of the colors in the CMYK color model. More particularly, each of the four pixel chambers 22 of the pixel element 20 has contained therein one of the colors of the CMYK color models. These colors are cyan, magenta, yellow and black. Alternatively, the pixel elements 20, that is, three separately arranged pixel chambers 22, and associated reservoirs may be arranged to operatively cooperate with each other to provide the RGB color space model.

Although the fluidic matrix display 18 provides an image using either the CMYK color space model or the RGB color space model, the operation of fluidic matrix display 18 is to be further described for the CMYK color space model with the understanding that the described operation is equally applicable to the RGB color space model.

In operation, and with reference to FIG. 4, one side of each of the pixel chambers 22 is connected to a reservoir 28, 32, 34 or 36 of colored liquid, via the associated valve 26. On the other side, the pixel chamber 22 is connected to the air spring chamber 24. Initially, the associated pixel chamber 22 and air spring chambers 24 are filled with air. The pixel chamber 22 is filled with colored liquid by opening the associated valve 26 connecting the colored liquid reservoir to the pixel chamber and pressurizing the colored liquid reservoir, via signal bus 44. This forces the colored liquid through the associated valve 26 and into the pixel chamber 22. The colored liquid entering the pixel chamber 22 displaces the air and forces the air into the air spring chamber 24 compressing the air in the air spring chamber 24. Equilibrium is achieved when the pressure in the air spring chamber 24 equals the pressure applied to the colored liquid.

Each of the pixel chambers 22 is emptied of liquid by removing the pressure from the colored liquid reservoirs 28, 32, 34 or 36 and allowing the compressed air in the air spring chamber 24 to push the colored liquid out of the pixel chamber 22. Equilibrium is again achieved when the air spring chamber pressure equals the colored liquid reservoir pressure of the colored liquid reservoirs 28, 32, 34 or 36.

The valve 26 associated with each pixel chamber 22 is positioned to control the flow of colored liquid from the liquid reservoirs 28, 32, 34 or 36 into and out of the pixel chamber 22. The associated valve 26 is preferably opened and closed by a pneumatic signal, such as that of signal 30. When the valve 26 is closed, no colored liquid may enter the pixel chamber 22 even though the colored liquid reservoirs 28, 32, 34 or 36 has been pressurized. Likewise when the valve 26 is off, no colored liquid may leave the pixel chamber 22, even though the colored liquid reservoirs 28, 32, 34 or 36 has been de-pressurized.

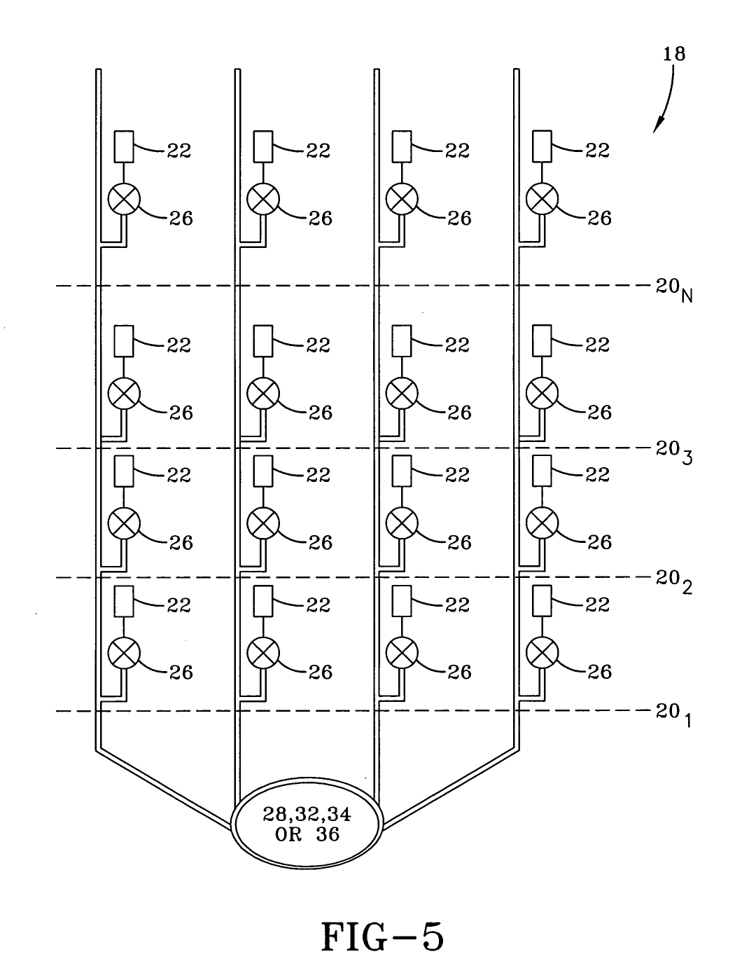

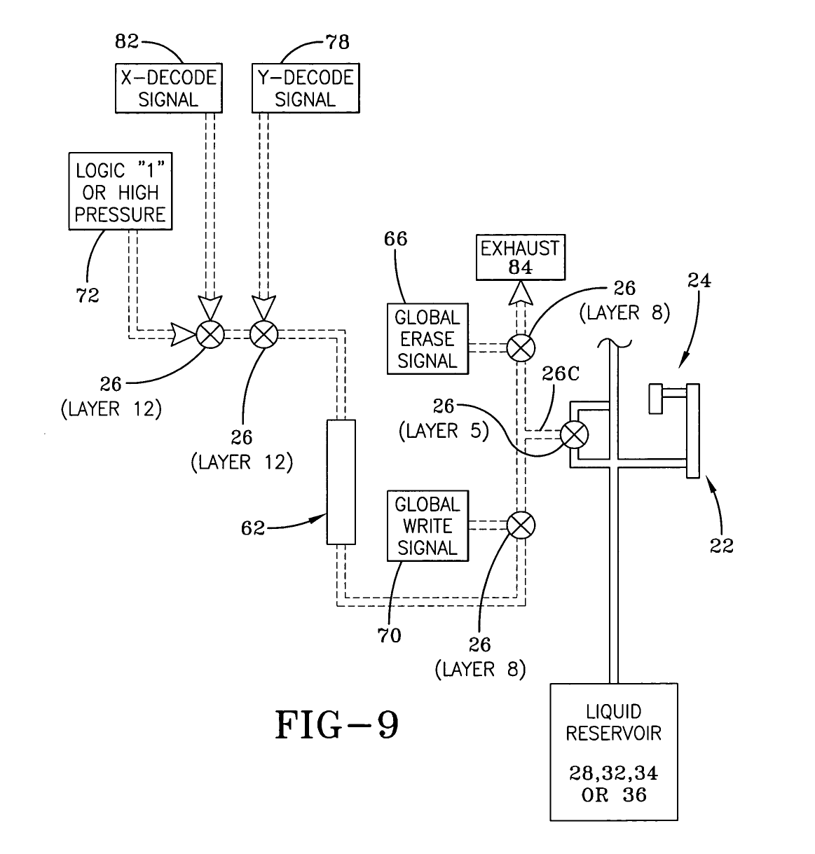

FIG. 5 is a schematic of an array of pixels 20₁, 20₂, 20₃ . . . 20_{N} making up the fluidics matrix display 18. The array of FIG. 5 is shown, for the sake of clarity, as lacking the associated air spring chambers 24 and the addressing arrangement for selectively actuating the valves 26. Each valve 26 is uniquely addressed by a row and column addressing scheme of the present invention to be further described hereinafter with reference to FIG. 9. Because of this scheme, each valve 26 and therefore each pixel chamber 22 can be written to independently and a resulting image displayed by the visual summation of all of the pixel chambers 22 of all of the pixel elements 20. In one embodiment described herein, the valve 26 controlling flow of colored liquid from the reservoirs 28, 32, 34 or 36 into and out of a pixel chamber 22 is a normally open valve controlled by a pneumatic signal, such as that of signal 30. However, other schemes including normally closed valves 26 and hydraulic control signals are also suitable. As seen in FIG. 4, each of the valves 26 has input, output, and control terminals or ports respectively shown with reference numbers 26A, 26B, and 26C. The input 26A is connected to the reservoirs 28, 32, 34 or 36. The control port 26C is connected to the signal path 30, which, in turn, is connected to the computer control 45. Each of the pixel chambers 22 has an input and output 22A and 22B, respectively. The input for 22A is respectively connected to the output port 26B of valve 26. Each of the air spring chambers 24 has an input port 24A. The input port 24A is connected to the output port 22B of the pixel chamber 22.

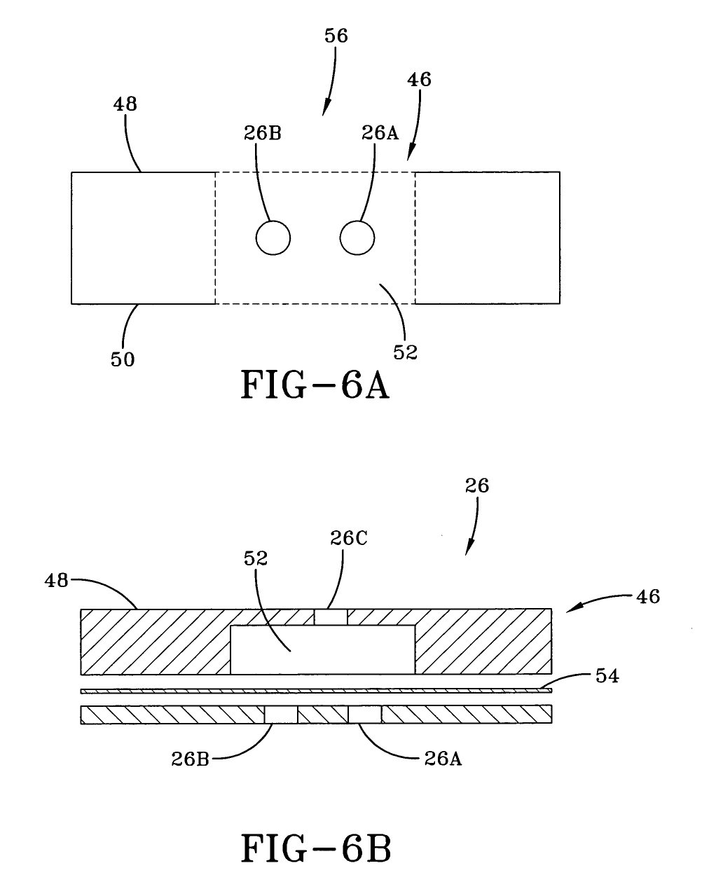

The colors being entered into each of the pixel chambers 22 is controlled by the associated valve 26, which may be further described with reference to FIG. 6 composed of FIGS. 6A and 6B, which are respectively top and side views of valve 26. Each of the valves 26 comprises a body member 46 having at least first and second opposite sides 48 and 50. The valve 26 has a valve chamber 52 (shown in phantom in FIG. 6A) within the body member 46. A first cutout is arranged in the first side 48 and serves as a control port 26C leading into the chamber 52 as shown in FIG. 6B. The valves 26 further have second and third cutouts, respectively, serving as input and output ports 26A and 26B and leading into the valve chamber 52. A diaphragm 54 is interposed between the valve chamber 52 and the input and output ports and 26A and 26B.

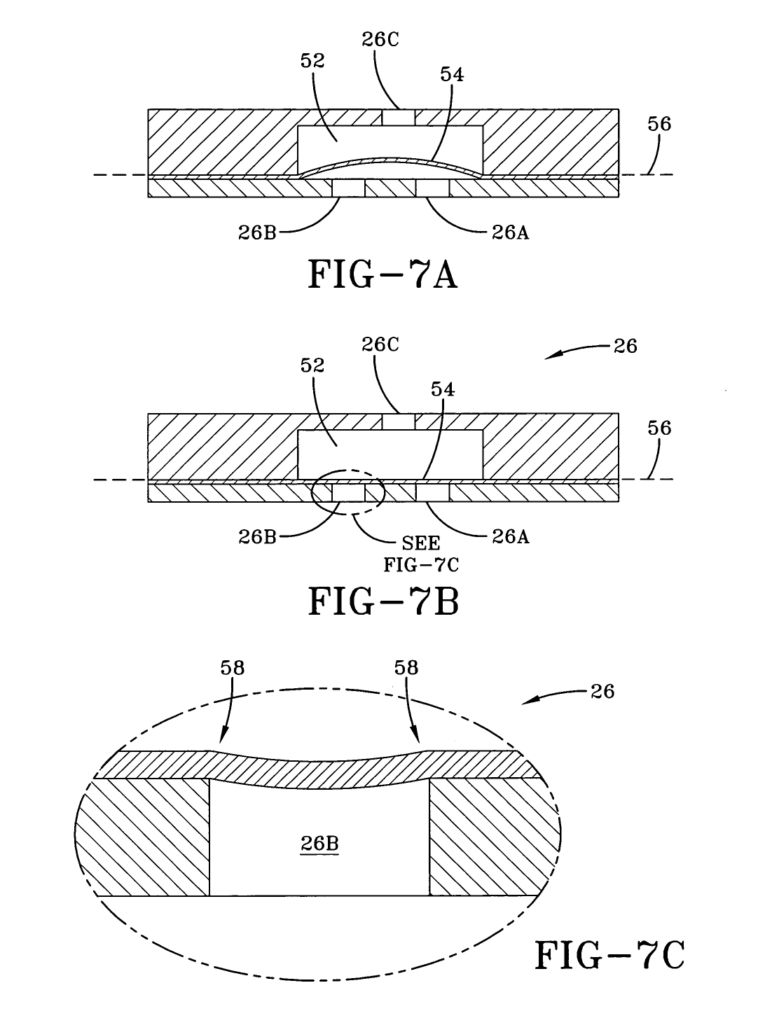

The diaphragm 54 may be a flexible plastic selected from the group comprising polyurethane, vinyl, nylon, and polyethylene. The diaphragm 54 may also comprise a rubber film of the materials selected from the group consisting of latex and silicone. The flexible plastic or rubber film serving as a diaphragm 54 may have a thickness of less than 0.001 inches. The valve 26 may be further described with reference to FIG. 7 composed of FIGS. 7A, 7B, and 7C.

The valves 26, shown in FIG. 7 are three terminal or port devices 26A, 26B, and 26C. These valves 26 may be entirely pneumatic, entirely hydraulic, or a combination of both. For all valves, there is an inlet (26A), an outlet (26B), and a control terminal (26C). A purely pneumatic valve 26 may use a pneumatic control signal 30 (shown in FIG. 4) to gate a pneumatic flow from valve inlet 26A to valve outlet 26B. Similarly, a purely hydraulic valve may use a hydraulic control signal applied to port 26C (shown in FIG. 7) to gate a hydraulic flow from valve inlet 26A to valve outlet 26B. A combination valve may use a pneumatic control signal applied to port 26C to gate a hydraulic flow from valve inlet 26A to valve outlet 26B or a hydraulic control signal to gate a pneumatic flow from valve inlet 26A to valve outlet 26B.

The particular type of control signal that may be used for valve 26 is obtained by selecting the proper signal generated by computer control 46 presented on path 30 (see FIG. 4) in operative cooperation with a pneumatic device in a manner known in the art.

FIG. 7A illustrates the valve 26 in its relaxed or open state, wherein fluid entering input port 26A is routed to output port 26B by means of the diaphragm 54. Conversely, FIG. 7B illustrates the valve 26 in its rigid or closed state, wherein diaphragm 54 prevents any fluid communications between ports 26A and 26B.

As seen in FIG. 7A, both the inlet 26A and outlet ports 26B extend through the valve seat plane 56 and the diaphragm 54 is parallel to the valve seat plane 56. Communication from the inlet port 26A to the outlet port 26B is accomplished when the diaphragm 54 is allowed to move away from the valve seat sealing surface 56 due to the pressure applied by the fluid entering from the inlet port 26A. As seen in FIG. 7B, communication from inlet 26A to outlet 26B is prevented when the diaphragm 54 is pressed against the valve sealing surface 56 by pressure applied to the back of the diaphragm through the signal applied to control port, that is, control port 26C. Sealing is accomplished by the diaphragm 54 conforming to a knife edge arrangement 58 for the outlet port 26B as shown in FIG. 7C.

The addressing scheme of the present invention allows each valve 26, and therefore, each pixel element 20₁ . . . 20ₘ . . . 20ₙ, to be written into independently and a resulting image displayed thereby. In the addressing scheme of the present invention, the valve 26 controlling flow of colored liquid into and out of a pixel chamber 22 is a normally open valve 26 controlled by a pneumatic signal applied to its control port 26C. However, other schemes including normally closed valves and hydraulic control signals are considered to be within the scope of the present invention.

The addressing scheme of the present invention serves two important functions. First, it allows for the independent addressing of each of the four valves 26 comprising a single pixel element 20. It should be recognized that each pixel element is made up of four layers each having a valve 26, a pixel chamber 22, and an air spring chamber 24. This addressing scheme is necessary to create an image where each pixel element will change from one image to the next image. Second, the present invention provides memory so a new image may be written while the current image is still being displayed. This is termed herein as “writing behind the scene”. This second feature is crucial due to the length of time it may take to write the new image. In practice, the transition from one image to the next cannot take longer than a few seconds or else one may lose its viewing audience. For example, a large billboard for out of home advertising can easily have 1 million pixel elements or more. Even writing at a speed of one pixel element every 10 milliseconds will take 10,000 seconds or nearly 3 hours to create a new image without the benefits of the present invention. Therefore, the new image must be written independently of the existing image and a quick transition made from existing image to new image, which is accomplished by the present invention.

For large format billboards handled by the present invention, that are designed to be viewed from a distance of 100 feet or more, the pixel element size is on the order of 0.25-0.5 inch high and of a square nature, although other shapes including rectangular dimensions work as well. The liquid and pneumatic channels, such as the pixel chamber 22, are on the order of 0.1 inch in width. The dimensions may be scaled down to produce a higher resolution display suitable for closer viewing. The addressing scheme of the present invention may be further described with reference to FIG. 8.

FIG. 8 is a side view of a section of a single pixel element 20 in the fluidics matrix display 18 showing the layering arrangement thereof comprising layers 1-14. More particularly, FIG. 8 only shows one-quarter (e.g., one pixel chamber 22) of a pixel element 20. The three non-shown sections of the pixel element are the same as that shown in FIG. 8. The pixel element 20 is constructed by forming the desired structures in sheets or layers of clear material and laminating the layers together until all the structures embodied in the layers 1-14, have been built up. Examples of materials that could be used are polycarbonate, acrylic, SAN and PVC, all known in the art, but other plastics could also be used. This layering 1-14 is shown diagrammatically in FIG. 8. The structures confined in the layers 1-14 may be formed in the clear materials by machining, molding, pressure forming, pressing and/or any other method common in the plastics forming industry. Non-optically clear materials may be used for some layers also. These layers could include any combination of ceramics or metals.

As seen in FIG. 8, a valve 26 is arranged between layers 5 and 4, two valves 26 are arranged between layers 8 and 7, and two valves 26 are arranged between layers 12 and 11. Further, as seen in FIG. 8 a pixel memory air chamber 62 is contained in layer 10 and the previously discussed liquid reservoir 28, 32, 34 or 36 and air spring chamber 24 are both contained in layer 6, while the pixel chamber 22 is contained in the uppermost layer 1 with its contents visible to the human eye, via the clear layer 1 formed of clear or opaque materials.

FIG. 8 further illustrates a control valve 64 in layer 8 responsive to an electrical signal 66, termed global erase, located in layer 9 and applied to the control terminal 26C of one of the valve 26 in layer 8, whereas a control valve 68 in layer responsive to an electrical signal 70, termed global write, located in layer 9, and applied to the control terminal 26C of the valve 26 in layer 8. In actuality, control valve 64 is not a separate valve, but rather the globe erase signal 66 is applied to the control terminal 26C of the respective valve 26, between layers 7 and 8. Similarly, control valve 68 is not a separate valve, but rather the signal 70 is applied to the control terminal 26C of the respective valve 26 between layers 7 and 8. Further, global erase 66 is just a path to send air into the control terminal 26C of the respective valve 26, and, similarly, global write 68 is just a path to send air into the control terminal 26C of the respective valve 26.

FIG. 8 still further illustrates air (72) contained in layer 11 and applied to the input 26A of one of the control valves in layer 12, which also has the operation of its control terminal 26C controlled by signal 78, termed Y-decode signal shown as being located in layer 14. The Y-decode signal 78 is delivered to control terminal 26 by way of passageways 74 and 76.

FIG. 8 also illustrates that the other valve 26 in layer 12 has its operation of its control terminal 26C controlled by the electrical signal 82 shown in layer 13 and termed X-decode signal. The X-decode signal 82 is delivered to the control terminal 26 by way of passageway 80.

FIG. 8 illustrates that the interconnection between the liquid reservoirs 28, 32, 34 or 36, pixel chamber 22, air spring chamber 24 is controlled by the valve 26 in layers 4 and 5. FIG. 8 further illustrates that the control valve 26, in particular, output port 26B thereof associated with global erase signal 66 is interconnected to exhaust 84, to be further described hereinafter with reference to FIG. 9 and, similarly, that the air 72 is interconnected to exhaust 84. The exhaust 84 associated with global erase signal 66 allows for vent/purge operation of the pixel memory air chamber 62 and, similarly, the exhaust 64 associated with air 72 allows for vent/purge operation of the pixel memory air chamber 62. The interconnection between the pixel memory air chamber 62 and the valve 26 in layer 5 controlling the flow of colored liquid into and out of pixel chamber 22, is controlled by the valves 26 in layers 7 and 8. Further, the interconnection between the air 72 in layer 11 and the pixel memory air chamber 62 is controlled by the two valves 26 in layers 11 and 12. All of the control signals shown in FIG. 8 are connected to the computer control 45 in a manner known in the art. The interconnection of all of the elements of FIG. 8 may be further described with reference to FIG. 9.

As seen in FIG. 9, the pixel memory air chamber 62 is located upstream from its associated pixel chamber 22 and its operation is controlled by the valves 26 that are responsive to the control signals 66, 70, 72, 78, and 82 selectively generated by computer control 45 of FIG. 4. The interconnections of all the signals shown in FIG. 9 to the computer control 45 are not shown for the sake of clarity, but are provided in a manner known in the art.

FIG. 9 is a schematic arrangement of the elements and signals previously described with reference to FIG. 8, but in addition thereto shows the valves 26 of layer 12, identified as 26 (layer 12), responsive to signals 78 and 82; the valves 26 of layer 8, identified as 26 (layer 8), responsive to signals 66 and 70; and the valve in layer 5, identified as 26 (layer 5) and responsive to the output of either of the valves 26 (layer 8). FIG. 9 further shows signal 84 (Exhaust) which is a release to atmosphere. transfer is done by taking the global write signal 70 “low”. This opens the valve 26 (layer 8) between the pixel memory air chamber 62 and the control port 26C of the valve 26 (layer 5). If the pixel memory air chamber 62 was “high”, this pressure is transferred to the control port 26C of the valve 26 (layer 5) shutting valve 26 (layer 5) off and preventing any flow of colored liquid either into or out of the pixel chamber 22. After so transferring the image, the global write signal 70 is taken “high” isolating the control port 26C of the valve 26 (layer 5) and fixing it in its current state. The image is now displayed by pressurizing the liquid reservoirs 28, 32, 34 or 36 and forcing the colored liquid into those pixel chambers 22 whose valve 26 (layer 5) is open. Those pixel chambers 22 whose associated valve 26 (layer 5) is closed will remain devoid of colored liquid.

An image is removed from the display by depressurizing the liquid reservoirs 28, 32, 34 or 36 and opening or taking low the control signal 66 global erase which vents any stored pressure from the control port 26C (layer 5) to atmosphere by way of exhaust 84.

It should now be appreciated that the practice of the present invention allows for new image to be written independently of an existing image and it provides for a quick transition to be made from a new to an existing image.

It should now be appreciated that the practice of the present invention provides a fluidics matrix display 18 that utilizes a CMYK or RGB color process involving the interaction of the colored fluids specified for each process. The fluidics matrix display 18 is a passive device and provides benefits that serve large format applications found in both indoor and outdoor advertising.

The invention has been described with reference to the preferred embodiments and alternatives as thereof It is believed that many modifications and alterations to the embodiments as discussed herein will readily suggest themselves to those skilled in the art upon reading and understanding the detailed description of the invention. It is intended to include all such modifications and alterations insofar as they come within the scope of the present invention.

What we claim is:

1. A fluidics matrix display comprising:
a) a plurality of pixel elements each comprising:
a₁) a plurality of pixel chambers stacked on each other and with each pixel chamber having an input port and an output port;
a₂) a plurality of air spring chambers each having input port connected to a respective output of said plurality of pixel chambers; and
a₃) a plurality of valves each having input, output, and control ports and each control port being responsive to a control signal so as to interconnect its input to its output port, said output ports thereof being connected to a respective input of said plurality of said pixel chambers; and
b) a plurality of sources of pressurized colored fluids respectively connected to a respective input port of said plurality of valves; and

2. The fluidics matrix display of claim 1, further comprising:
a) a computer control selectively generating said control signal of said control port of said plurality of valves.

3. The display system according to claim 1, wherein said plurality of sources of pressurized color fluids consists of colors red, green and blue.

4. The display system according to claim 1, wherein said plurality of sources of pressurized color fluids consists of the colors cyan, magenta, yellow and black.

5. The display system according to claim 4, wherein said plurality of pixel chambers consisting of four layers and wherein said four pixel chambers are respectively connected to said cyan colored fluid, said magenta colored fluid, said yellow colored fluid, and said black colored fluid.

6. The display according to claim 1, wherein each of said valves comprises:
a) a body member having at least first and second opposite sides;
b) a valve chamber located within said body member;
c) a first cutout in said first side and serving as said control port and leading into said valve chamber;
d) second and third cutouts in said second side and respectively serving as said input and output ports and each leading into said valve chamber; and
e) a diaphragm interposed between said valve chamber thereof and said input and output ports thereof.

7. The display according to claim 6, wherein said diaphragm comprises a section so as to provide a knife edge seal when said diaphragm mates with said output port.

8. The display according to claim 6, wherein said diaphragm is a flexible plastic selected from the group consisting of polyurethane, vinyl, nylon and polyethylene.

9. The display according to claim 6, wherein said diaphragm is a rubber film of a material selected from the group consisting of latex and silicone.

10. The display according to claim 8, wherein said flexible plastic is of a thickness of less than about 0.001 inches.

11. The display according to claim 9, wherein said rubber film is of a thickness of less than about 0.001 inches.

12. The display according to claim 2, wherein said display further comprises a plurality of pixel memory air chambers respectively connected to the control ports of said plurality of valves.

13. A method of displaying images for human viewing comprising the steps of:
a) providing a plurality of pixel elements each comprising:
a₁) a plurality of pixel chambers stacked on each other and with each pixel chamber having an input port and an output port;
a₂) a plurality of air spring chambers each having input port, and connected to a respective output of said plurality of pixel chambers; and
a₃) a plurality of valves each having input, output and control ports and each being responsive to a first control signal so as to interconnect its input to its output port, said output ports thereof being connected to a respective input port of said plurality of said pixel chambers;
b) providing a plurality of sources of pressurized colored fluids;
c) connecting said plurality of sources of pressurized transparent fluids to a respective input port of said plurality of valves;
d) providing a computer control selectively generating said control signal to said control ports of said plurality of valves; and
e) operating said computer to selectively generate said control signal so that colored fluids enter and leave each of said pixel chambers in a predetermined manner to produce an image for said human viewing.

14. The method according to claim 12, wherein said method further comprises:
f) providing a plurality of pixel memory air chambers for storing the status of the contents to be written into each of said pixel chambers.
